(19) United States
(12) Patent Application Publication
(10) Pub. No.: US 2026/0192379 A1
(43) Pub. Date: Jul. 9, 2026

(54) WELDING TORCH ASSEMBLIES WITH INTEGRATED VISION SYSTEMS

(71) Applicant: Novarc Technologies Inc., North Vancouver (CA)

(72) Inventors: Abdolreza ABDOLLAHI, North Vancouver (CA); Soroush KARIMZADEH, North Vancouver (CA); Mahyar ASADI, North Vancouver (CA); Soroush BAGHERI, Vancouver (CA); Amin GHASEMAZAR, North Vancouver (CA)

(21) Appl. No.: 19/130,258

(22) PCT Filed: Nov. 22, 2023
(86) PCT No.: PCT/CA2023/051568

§ 371 Date: May 15, 2025

Related U.S. Application Data
(60) Provisional application No. 63/384,720, filed on Nov. 22, 2022.

(51) Int. Cl. B23K 9/095; B23K 37/02; B25J 15/00; B25J 19/02; H04N 13/236; H04N 13/239; H04N 13/243; H04N 13/254; H04N 23/57; H04N 23/90

(52) U.S. Cl. CPC B23K 9/0956; B23K 37/0229; B25J 15/0019; B25J 19/023; H04N 13/236; H04N 13/239; H04N 13/243; H04N 13/254; H04N 23/57; H04N 23/90

(57) ABSTRACT

The present disclosure provides apparatus for mounting a welding torch on a robotic arm comprising a mounting body having a torch connector thereon for holding the welding torch and an arm connector for coupling the mounting body to the robotic arm, and one or more cameras integrated into the mounting body and configured to capture images of an active welding area at a lower end of the welding torch from two or more angles for generating a three dimensional view of a weld seam.

### CROSS-REFERENCE TO RELATED APPLICATION

This patent application claims priority to U.S. provisional patent application No. 63/384,720 filed Nov. 22, 2022, the entire content of which is incorporated by reference herein.

### TECHNICAL FIELD

The present disclosure relates to robotic welding systems.

### BACKGROUND

Various types of welding systems utilize cameras and other sensors to control and/or monitor robotic welding operations. Many existing vision-based solutions used for monitoring operations of robotic welding systems are not suitable for use in situations where there is limited clearance around the welding torch.

Examples of prior art vision-based systems for use in welding operations include Korean patent No. KR1020050068079, and Chinese utility models No. CN205614171 and No. CN213560726.

The inventors have determined a need for improved apparatus and methods for capturing images (both still images and videos) of welding operations.

### SUMMARY

One aspect of the present disclosure provides apparatus for mounting a welding torch on a robotic arm comprising a mounting body having a torch connector thereon for holding the welding torch and an arm connector for coupling the mounting body to the robotic arm, and one or more cameras integrated into the mounting body and configured to capture images of an active welding area at a lower end of the welding torch from two or more angles for generating a three dimensional view of a weld seam.

Another aspect of the present disclosure provides a welding torch assembly comprising a welding torch, a mounting body coupled to the welding torch, the mounting body having an arm connector thereon for coupling the mounting body to a robotic arm, and one or more cameras integrated into the mounting body and configured to capture images of an active welding area at a lower end of the welding torch from two or more angles for generating a three dimensional view of a weld seam.

Further aspects of the present disclosure and details of example embodiments are set forth below.

### DRAWINGS

The following figures set forth embodiments in which like reference numerals denote like parts. Embodiments are illustrated by way of example and not by way of limitation in the accompanying figures.

FIG. 1 shows a mounting structure with integrated cameras for coupling a welding torch to a robotic arm according to one aspect of the present disclosure.

FIG. 1A shows the mounting structure of FIG. 1 mounted on a robotic arm according to one aspect of the present disclosure.

FIG. 1B shows the mounting structure of FIG. 1 holding a straight welding torch.

FIG. 2 shows a mounting structure with integrated cameras for coupling a welding torch to a robotic arm according to another aspect of the present disclosure.

FIG. 2A shows the mounting structure of FIG. 2 holding a straight welding torch.

FIG. 3 shows a mounting structure with integrated cameras for coupling a welding torch to a robotic arm according to another aspect of the present disclosure.

FIG. 3A shows the mounting structure of FIG. 3 holding a straight welding torch.

FIG. 4 shows a mounting structure with integrated cameras for coupling a welding torch to a robotic arm according to another aspect of the present disclosure.

FIG. 4A shows the mounting structure of FIG. 4 holding a straight welding torch.

FIG. 5 shows a mounting structure with integrated cameras for coupling a welding torch to a robotic arm according to another aspect of the present disclosure.

FIG. 5A shows the mounting structure of FIG. 5 mounted on a robotic arm according to one aspect of the present disclosure.

FIG. 6 shows a mounting structure with integrated cameras for coupling a welding torch to a robotic arm according to another aspect of the present disclosure.

FIG. 7 shows a mounting structure with integrated cameras for coupling a welding torch to a robotic arm according to another aspect of the present disclosure.

FIG. 7A shows the mounting structure of FIG. 7 holding a straight welding torch.

### DETAILED DESCRIPTION

The following describes example welding torch assemblies equipped with integrated camera systems configured to capture images (both still images and videos) of an active welding area at a lower end of the welding torch from two or more angles for generating a three dimensional view of a weld seam at the point of welding. Some embodiments comprise a mounting structure with a plurality of integrated cameras for coupling a welding torch to a robotic arm, and can be used with many different types of existing welding torches and robotic arms. As used herein, the term “robotic arm” is used to refer to all types of mechanized manipulators. Images from the camera system are provided to an image processing system, such as for example the NovEye™ system from Novarc Technologies Inc., for controlling operation of the welding torch and motions of the robotic arm. Examples of how images from cameras positioned to capture images of a welding operation are disclosed, for example, in PCT Publications No. WO2019153090 and WO2022126274 by Novarc Technologies Inc., which are hereby incorporated by reference herein. The welding torch assemblies and mounting structures disclosed herein with integrated vision systems can be mounted to all types of welding robots and mechanized arms.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

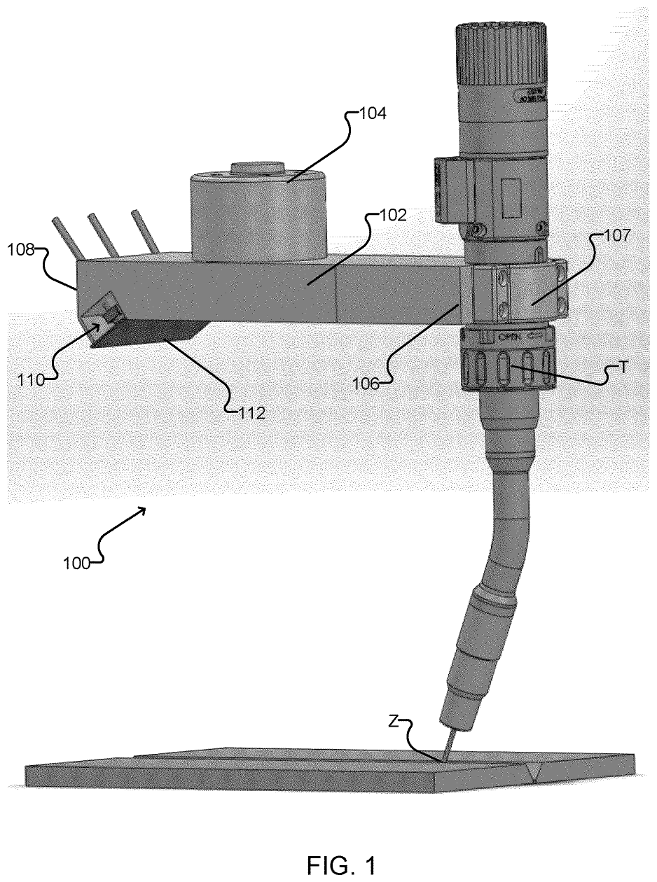

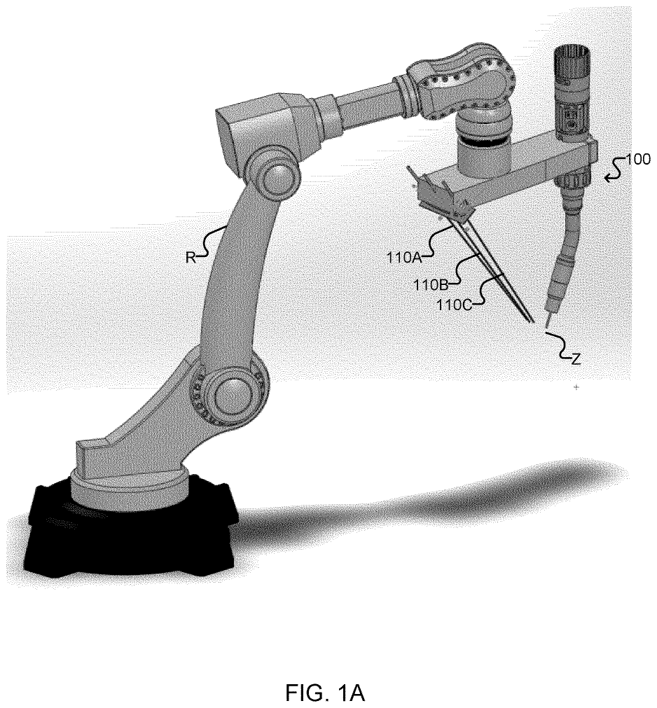

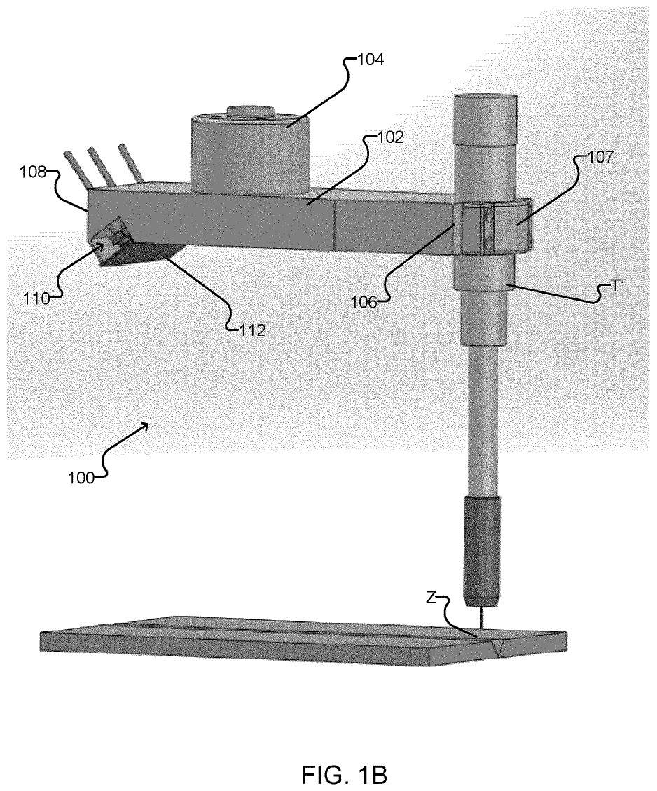

FIG. 1 shows an example apparatus 100 for mounting a welding torch on a robotic arm according to one embodiment of the present disclosure. The apparatus 100 comprises a mounting body 102 having an arm connector 104 thereon for connection to the end of a robotic arm. In some embodiments, the arm connector 104 may comprise a mounting flange with four bolts and a locator pin (not shown) for connection to some types of robotic arms, although the configuration of the arm connector 104 will depend on the configuration and the brand of the robotic arm. FIG. 1A shows the apparatus 100 of FIG. 1 mounted on an example six-axis robotic arm, but it is to be understood that the apparatus 100 could be mounted on any type of robotic manipulator.

The mounting body 102 has a plurality of cameras 110 (three in the illustrated example) integrated thereinto, which are oriented to capture images of a welding point P from different angles. In the illustrated example, the three cameras 110 are positioned within the body such that their optical axes 110A, 110B, 110C converge on the welding zone Z to capture images of the weld seam as it is formed. The images from the cameras 110 are provided to an image processing system for seam tracking, distance control, and/or control of welding parameters of the welding operation.

Capturing real-time images of the weld pool from different angles allows the image processing system to generate a three dimensional view showing the size and shape of a weld pool during a welding operation and the position of the weld pool relative to a weld seam.

In the FIG. 1 example, the mounting body 102 comprises an elongated body having a first end 106 and a second end 108, and a torch T is configured to be held by a torch bracket 107 connected to the first end 106 of the body 102. The cameras 110 are positioned within an enclosure in the body 102 near the second end 108, and are covered by a window 112 formed of one or more layers of transparent or partially transparent material, such as for example, auto-darkening filters, heat shields, shaded glass, or other suitable materials.

In the FIG. 1 example, the apparatus 100 is depicted as holding an angled or “goose neck” welding torch T, but it is to be understood that the apparatus 100 can be configured for holding other types of welding torches by adjusting the angles of the cameras 110. For example, FIG. 1B shows the apparatus 100 holding a straight welding torch T′.

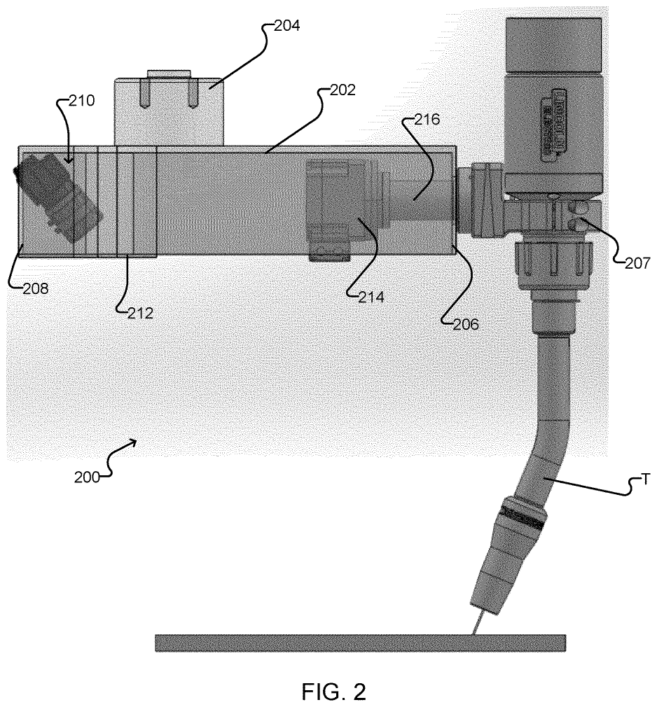

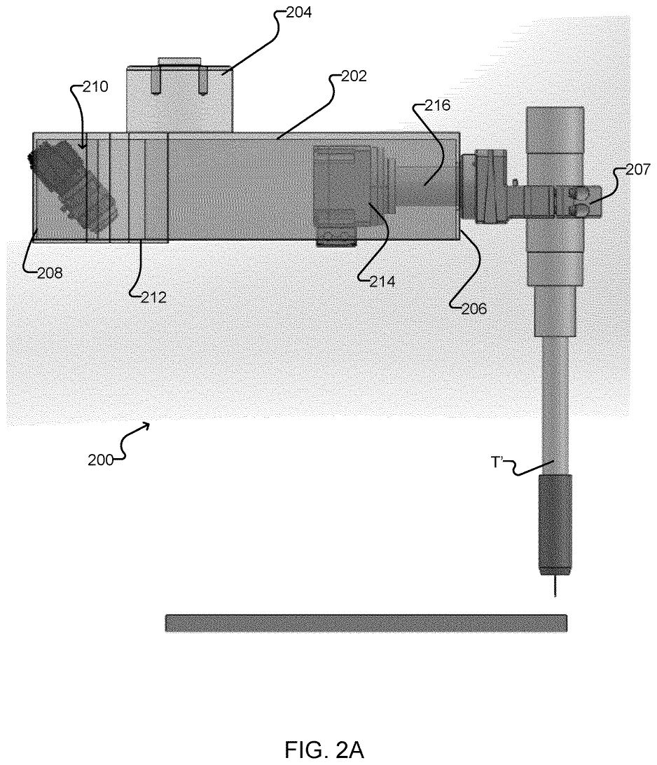

FIG. 2 shows an example apparatus 200 for mounting a welding torch on a robotic arm according to another embodiment of the present disclosure. The apparatus 200 is similar in some respects to apparatus 100 of FIG. 1, in that apparatus 200 comprises an elongated mounting body 202 having an arm connector 204 thereon and a first end 206 and a second end 208, and cameras 210 are positioned within an enclosure in the body 202 near the second end 208, and are covered by a window 212. In the FIG. 2 embodiment, the apparatus 200 comprises a weave motor 214 mounted in the body 202 and a rotating element 216 extending out the first end 206 of the body 202, and a torch bracket 207 which is connected to the rotating element 216, such that the weave motor 214 can be actuated to cause the torch T to move side to side in a weaving motion during welding operations (for example, when welding a seam in a relatively wide gap). The cameras 210 move with the torch T as it is moved by the robotic arm or other actuator, but are isolated from the weaving motion imparted by the weave motor 214 such that the cameras 210 remain focused on the seam.

In the FIG. 2 example, the apparatus 200 is depicted as holding an angled or “goose neck” welding torch T, but it is to be understood that the apparatus 200 can be configured for holding other types of welding torches by adjusting the angles of the cameras 210. For example, FIG. 2A shows the apparatus 200 holding a straight welding torch T′.

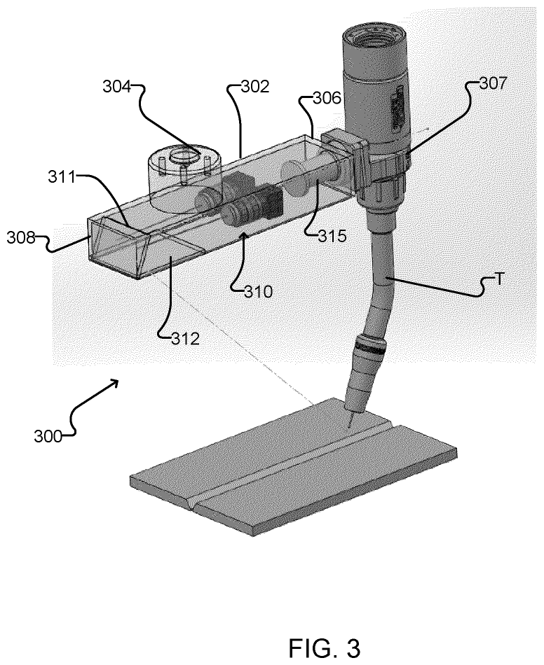

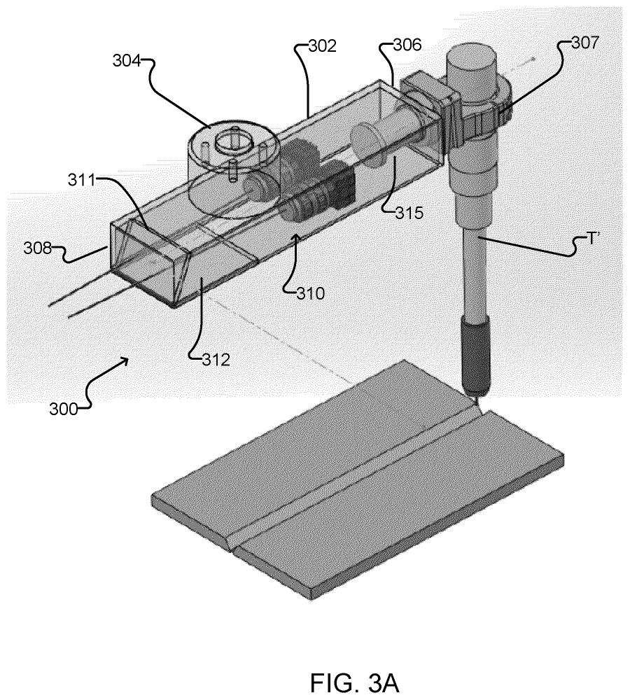

FIG. 3 shows an example apparatus 300 for mounting a welding torch on a robotic arm according to another embodiment of the present disclosure. The apparatus 300 is similar in some respects to apparatus 100 of FIG. 1 and apparatus 200 of FIG. 2, in that apparatus 300 comprises an elongated mounting body 302 having an arm connector 304 thereon and a first end 306 and a second end 308, and cameras 310 (two in the illustrated embodiment) are positioned within an enclosure in the body 302. Apparatus 300 comprises a torch bracket 307 connected to a mounting element 315 extending from the first end 306 of the body 302. In the FIG. 3 embodiment, the body 302 takes up a smaller volume, particularly at the second end 308, and the cameras 310 are positioned in a central portion of the body 302 and point towards a mirror 311 near the second end 308. The mirror 311 is positioned next to a window 312 and oriented to reflect images from the welding zone to the cameras 310. In some embodiments, instead of two cameras 310, a single camera could be used, wherein the single camera points towards a plurality of mirrors configured to reflect images of the welding zone from different angles toward the single camera.

In the FIG. 3 example, the apparatus 300 is depicted as holding an angled or “goose neck” welding torch T, but it is to be understood that the apparatus 300 can be configured for holding other types of welding torches by adjusting the angles of the cameras 310. For example, FIG. 3A shows the apparatus 300 holding a straight welding torch T′.

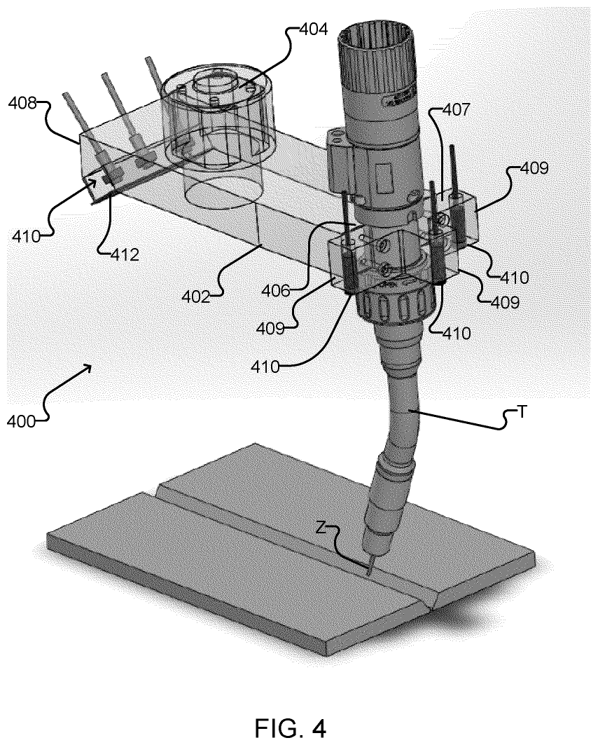

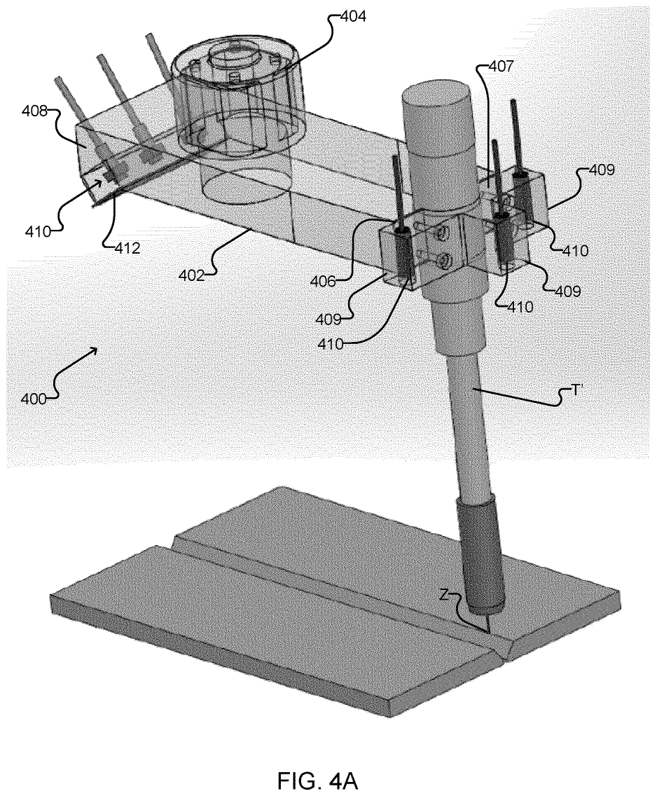

FIG. 4 shows an example apparatus 400 for mounting a welding torch on a robotic arm according to another embodiment of the present disclosure. The apparatus 400 is similar in some respects to apparatus 100 of FIG. 1 and apparatus 200 of FIG. 2, in that apparatus 400 comprises an elongated mounting body 402 having an arm connector 404 thereon and a first end 406 and a second end 308, and cameras 410 (three in the illustrated embodiment) are positioned within an enclosure in the body 402 near the second end 408, and are covered by a window 412. The apparatus 400 also comprises a torch bracket 407 having three protrusions 409 extending outwardly therefrom, and three additional cameras 410 that are positioned in the protrusions 409 to capture images from all sides of torch T.

In the FIG. 4 example, the apparatus 400 is depicted as holding an angled or “goose neck” welding torch T, but it is to be understood that the apparatus 400 can be configured for holding other types of welding torches by adjusting the angles of the cameras 410. For example, FIG. 4A shows the apparatus 400 holding a straight welding torch T′.

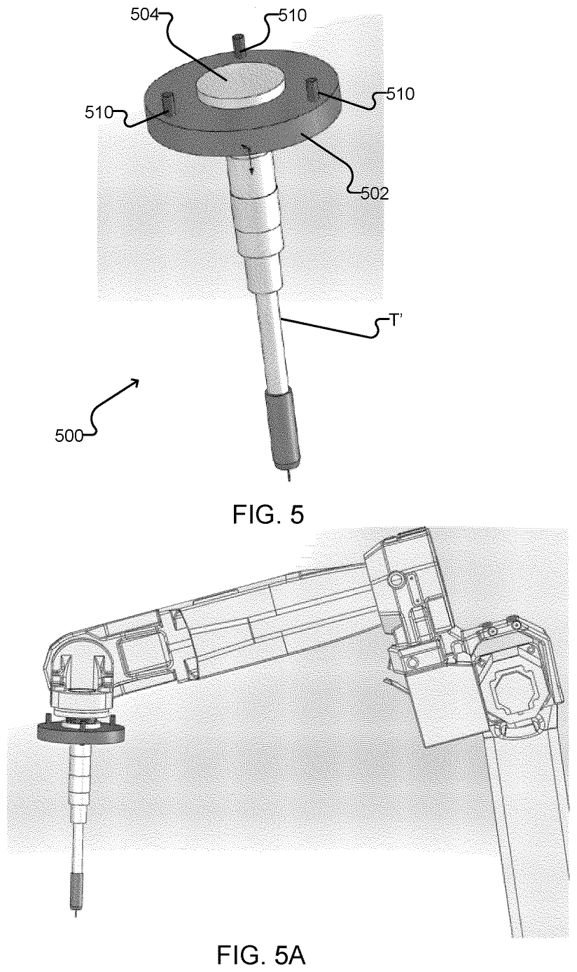

FIG. 5 shows an example apparatus 500 for mounting a welding torch on a robotic arm according to another embodiment of the present disclosure. In the FIG. 5 embodiment, the apparatus 500 comprises a mounting body 502 in the form of a flange extending radially outwardly around an upper end of a straight welding torch T′. The mounting body 502 has an arm connector 504 thereon for connecting to a robotic arm. In some embodiments, the arm connector 504 may comprise a mounting flange with four bolts and a locator pin (not shown) for connection to some types of robotic arms, although the configuration of the arm connector 504 will depend on the brand of robotic arm. A plurality of cameras 510 are mounted in the flange of the mounting body 502, and oriented to capture images of the welding zone from a plurality of angles. In the illustrated example, apparatus 500 comprises three cameras 510 evenly spaced around the flange. In other embodiments a different number of cameras 510 can be positioned in the flange, and the cameras may or may not be evenly spaced around the flange. FIG. 5A shows the apparatus 500 of FIG. 5 mounted on a robotic arm according to one aspect of the present disclosure.

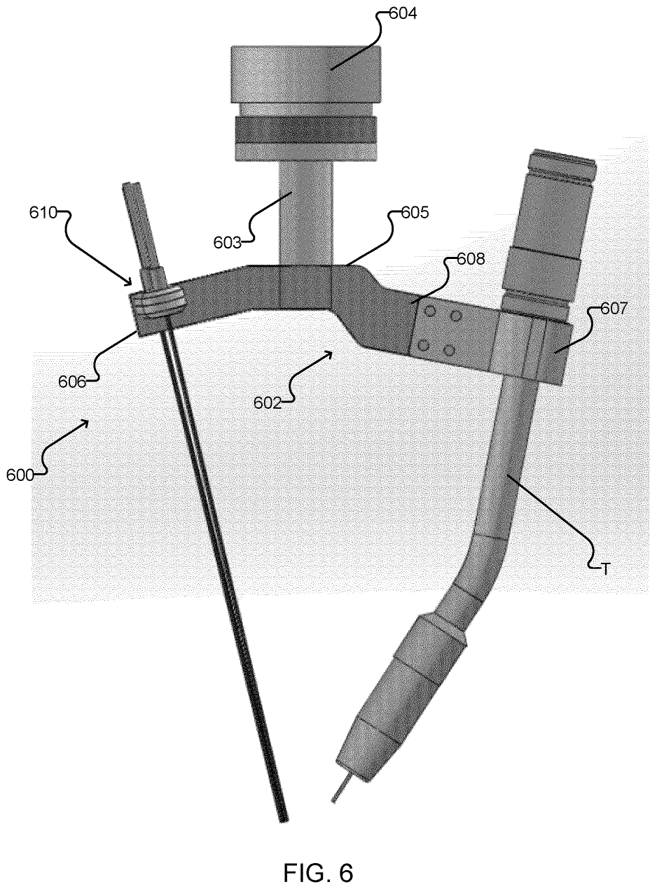

FIG. 6 shows an example apparatus 600 for mounting a welding torch on a robotic arm according to another embodiment of the present disclosure. In the FIG. 6 embodiment, the apparatus 600 comprises a mounting body 602 in the form of a bent elongated body 602 with first and second ends 606 and 608 angled downwardly from a central portion 605. The central portion 605 of the mounting body 602 is coupled to an arm connector 604 by a shaft 603. The length of shaft 603 may be selected to provide a desired amount of clearance between the torch T and the robotic arm (not shown) connected to the arm connector 604. A torch bracket 607 is positioned on the first end 606 of the mounting body 602, and a plurality of cameras 610 are mounted on the second end 608 of the mounting body 206.

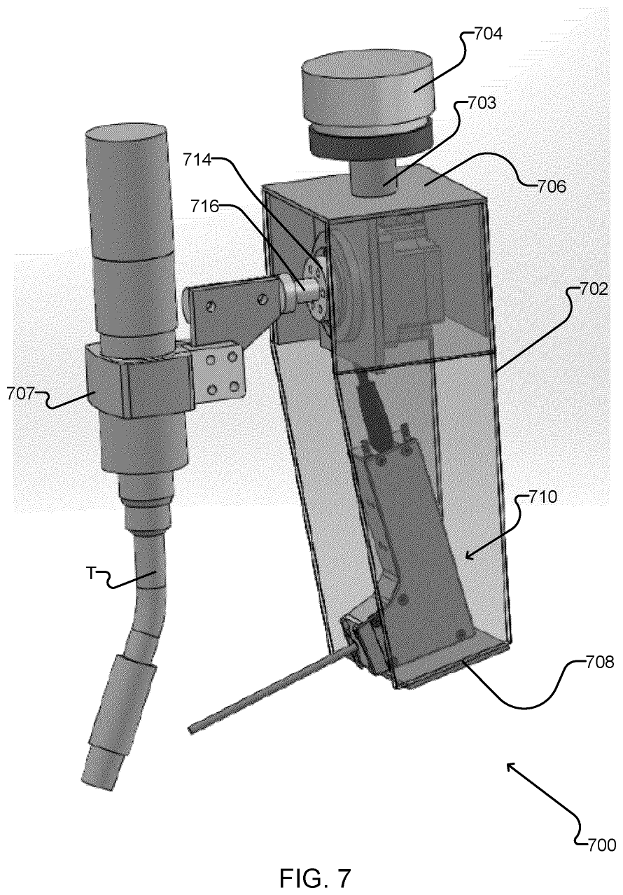

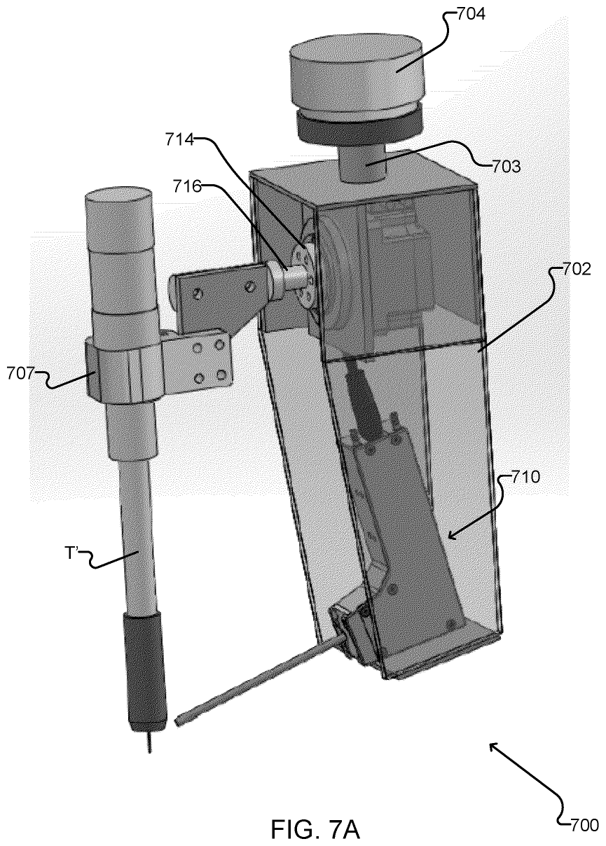

In the example embodiments of FIG. 1-4 and 6, the mounting body comprised an elongated body elongated along a first direction, and the torch connector is configured to hold the welding torch in an orientation along a second direction generally perpendicular to the first direction. In other embodiment, depending on the spatial constraints of the desired welding operation(s), the apparatus may be configured to hold the welding torch in different orientations. For example FIG. 7 shows an example apparatus 700 for mounting a welding torch on a robotic arm according to another embodiment of the present disclosure, wherein the apparatus is configured to hold the welding torch T in an orientation generally parallel to an orientation of an elongated mounting body 702. In the FIG. 7 example, an arm connector 704 is connected to a first end 706 of the elongated mounting body 702, and a camera assembly 710 is positioned withing the elongated mounting body 702 near a second end 708. The camera assembly 710 and configured with an angled optical head comprising one or more lenses oriented such that their optical axis is focused on the welding zone and one or more mirrors oriented to direct light from the lenses generally perpendicularly (e.g., at an angle between about 70 and about 110 degrees) towards one or more filters and photo-sensitive sensors closer to the middle of the elongated mounting body 702. In the illustrated example, only one camera assembly 710 is shown, but it is to be understood that the apparatus 700 of FIG. 7 could comprise two, three, or more camera assemblies housed within the elongated mounting body 702. In the FIG. 7 embodiment, the apparatus 700 comprises a weave motor 714 mounted in the body 702 and a rotating element 716 extending out the side of the body 702, the near the first end 706 thereof, and a torch bracket 707 which is connected to the rotating element 716, such that the weave motor 714 can be actuated to cause the torch T to move side to side in a weaving motion during welding operations (for example, when welding a seam in a relatively wide gap). The camera assembly(ies) 710 move with the torch T as it is moved by the robotic arm or other actuator, but are isolated from the weaving motion imparted by the weave motor 714 such that the camera(s) remain focused on the seam.

In the FIG. 7 example, the apparatus 700 is depicted as holding an angled or “goose neck” welding torch T, but it is to be understood that the apparatus 700 can be configured for holding other types of welding torches by adjusting the angle(s) of the optical head(s) of the camera assembly(ies) 710. For example, FIG. 7A shows the apparatus 700 holding a straight welding torch T′.

In some implementations of the embodiments described above with reference to FIGS. 1-7, at least one of the cameras 110/210/310/410/510/610/710 comprises an integrated illumination system including one or more light emitting elements arranged around a lens of the at least one camera. In some implementations, the apparatus 100/200/300/400/500/600/700 of the embodiments described above with reference to FIGS. 1-7 is configured for connection to a source of compressed air or other cooling fluid for directing cooling fluid towards the cameras 110/210/310/410/510/610/710. The cooling fluid may also be used for keeping the cameras clean and clear of smoke, weld spatter, dust, or other debris. For example, in some embodiments, an air blade or similar air direction assembly is coupled to the apparatus 100/200/300/400/500/600/700 and configured to direct forced air towards cameras 110/210/310/410/510/610/710 for cooling and/or cleaning thereof.

As one skilled in the art will appreciate in light of the above disclosure, by providing one or more cameras configured to capture real time images of a welding operation, apparatus according to some embodiments of the present disclosure facilitate real-time and adaptive control of welding. The camera visualizes the real-time instance of welding puddle (or “weld pool”), weldment geometry under the arc, the torch, wire, tack welds, root opening, high-low, gap, and other visual parameters that are important for welders. In embodiments with at least two cameras (or a single camera configured with optics for capturing images from different angles), apparatus according to the present disclosure allow for capture of stereo vision images with depth information, and removes the sensitivity of the cameras to the tilt in the welding direction. The depth information provides the ability to generate three dimensional views of the welding features that significantly improves the visual cognition for real-time adaptive control of welding. Further, in embodiments with three or more cameras configured to capture images spanning 360 degrees around the welding torch, apparatus according to the present disclosure allow the image processing system to generate a bird's eye view of the welding operation. A bird's eye view can be configured to maintain the welding view independent of the local movement and/or rotation of the torch during welding. Also, in certain preferred embodiments of the present disclosure (regardless of the number and configuration of cameras), the apparatus is configured to generate time-stamped images of welding operations to facilitate pre and post-weld inspection in addition to the welding control.

The embodiments of the systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface. For example, the programmable computers may be a server, network appliance, on-board controllers of a connected or autonomous vehicle, set-top box, embedded device, computer expansion module, personal computer, laptop, personal data assistant, cloud computing system or mobile device. A cloud computing system is operable to deliver computing service through shared resources, software and data over a network.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Embodiments described herein may relate to various types of computing applications, such as image processing and generation applications, computing resource related applications, speech recognition applications, video processing applications, semiconductor fabrication, and so on. By way of illustrative example embodiments may be described herein in relation to image-related applications.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various example embodiments described herein.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As will be apparent to those skilled in the art in light of the foregoing disclosure, many alterations and modifications are possible to the methods and systems described herein. While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as may reasonably be inferred by one skilled in the art. The scope of the claims should not be limited by the embodiments set forth in the examples, but should be given the broadest interpretation consistent with the foregoing disclosure.

The present disclosure may be embodied in other specific forms without departing from its spirit or essential characteristics. The described embodiments are to be considered in all respects only as illustrative and not restrictive.

1. Apparatus for mounting a welding torch on a robotic arm, the apparatus comprising:
a mounting body having a torch connector thereon for holding the welding torch and an arm connector for coupling the mounting body to the robotic arm; and
one or more cameras integrated into the mounting body and configured to capture images of an active welding area at a lower end of the welding torch from two or more angles for generating a three dimensional view showing the size and shape of a weld pool during a welding operation and the position of the weld pool relative to a weld seam.

2. The apparatus of claim 1 wherein the mounting body comprises an elongated body having a first end and a second end, the torch connector is on the second end of the body, and the one or more cameras are mounted near the first end of the body.

3. The apparatus of claim 2 wherein the one or more cameras are mounted in an enclosure within the body and configured to capture images of the active welding area through a window formed near the first end of the body.

4. The apparatus of claim 3 wherein the one or more cameras comprise at least two cameras oriented to point directly through the window.

5. The apparatus of claim 3 wherein the one or more cameras comprise at least two cameras oriented to point towards a mirror positioned next to the window and configured to reflect an image of the active welding area.

6. The apparatus of claim 3 wherein the one or more cameras comprise a single camera oriented to point towards at least two mirrors positioned next to the window and configured to reflect images of the active welding area from different angles.

7. The apparatus of claim 2 comprising a weave actuator connected between the body and the torch connector, wherein the weave actuator is configured to rotate the torch connector relative to the body such that the welding torch is controllable to execute a weave motion without the one or more cameras moving in the weave motion.

8. The apparatus of claim 2 wherein the torch connector is configured to hold the welding torch in an orientation generally perpendicular to an orientation of the elongated body.

9. The apparatus of claim 2 wherein the torch connector is configured to hold the welding torch in an orientation generally parallel to an orientation of the elongated body.

10. The apparatus of claim 1 wherein the torch connector comprises a torch bracket extending around the torch, and the apparatus further comprises a plurality of additional cameras mounted in the torch bracket.

11. The apparatus of claim 10 wherein the torch bracket comprises a plurality of protrusions extending therefrom and the additional cameras are mounted in the protrusions.

12. The apparatus of claim 1 wherein the mounting body comprises a flange extending radially outwardly around an upper end of the welding torch, and the one or more cameras comprise a plurality of cameras mounted in the flange.

13. The apparatus of claim 1 wherein the one or more cameras comprise at least three cameras positioned to collectively capture images spanning 360 degrees around the welding torch for generating a bird's eye view of the welding operation.

14. The apparatus of claim 1 wherein at least one camera comprises an integrated illumination system including one or more light emitting elements arranged around a lens of the at least one camera.

15. A welding torch assembly comprising:
a welding torch;
a mounting body connected to the welding torch, the mounting body having an arm connector thereon for coupling the mounting body to a robotic arm; and
one or more cameras integrated into the mounting body and configured to capture images of an active welding area at a lower end of the welding torch from two or more angles for generating a three dimensional view showing the size and shape of a weld pool during a welding operation and the position of the weld pool relative to a weld seam.

16. The welding torch assembly of claim 15 wherein the mounting body is removably connected to the welding torch.

17. The welding torch assembly of claim 15 wherein the mounting body is integrated with the welding torch.
